(19) United States
(12) Patent Application Publication
(10) Pub. No.: US 2019/0309676 A1
(43) Pub. Date: Oct. 10, 2019

(54) INTERNAL COMBUSTION ENGINE

(71) Applicant: TOYOTA JIDOSHA KABUSHIKI KAISHA, Toyota-shi (JP)

(72) Inventor: Masakazu TABATA, Susono-shi (JP)

(73) Assignee: TOYOTA JIDOSHA KABUSHIKI KAISHA, Toyota-shi (JP)

(21) Appl. No.: 16/283,445

(22) Filed: Feb. 22, 2019

(30) Foreign Application Priority Data
Apr. 6, 2018 (JP) 2018-073903

(51) Int. Cl. F02B 37/02; F02F 1/36; F01N 3/28; F01D 25/16; F01D 1/04; F01D 25/24

(52) U.S. Cl. CPC F02B 37/02; F02F 1/36; F01N 3/2892; F05D 2220/40; F01D 1/04; F01D 25/24; F01D 25/162

(57) ABSTRACT

An internal combustion engine includes an exhaust gas passage, a water-cooled cylinder head and a turbocharger. The turbocharger includes: a compressor impeller; an axial flow turbine wheel coupled to the compressor impeller through a rotational shaft; a bearing that supports a portion of the rotational shaft located between the compressor impeller and the turbine wheel; and a housing that houses at least the compressor impeller and the bearing among the compressor impeller, the bearing and the turbine wheel. The turbine wheel is coupled to the rotational shaft such that the outlet of turbine blades of the turbine wheel is located on the side of the compressor impeller. The housing is fastened to the cylinder head, directly or with a first gasket interposed between the housing and the cylinder head, such that the turbine wheel is opposed to the cylinder head.

### CROSS-REFERENCE TO RELATED APPLICATION

This application is based on and claims the benefit of Japanese Patent Application No. 2018-073903, filed on Apr. 6, 2018, which is incorporated by reference herein in its entirety.

### BACKGROUND

### Technical Field

The present disclosure relates to an internal combustion engine, and more particularly to an internal combustion engine equipped with a turbocharger that includes an axial flow turbine.

### Background Art

For example, JP 2017-145748 A discloses an internal combustion engine equipped with a turbocharger. This turbocharger includes a compressor, a turbine for supercharging, which is driven to rotate the compressor, and a turbine for generating electric power, which is driven to rotate a generator. The turbine for generating electric power is axial flow type.

More specifically, a wheel of the turbine for generating electric power is arranged downstream of the wheel of the turbine for supercharging, and is coupled to the generator through a rotational shaft. In other words, the wheel of the turbine for generating electric power is arranged at an end portion of the above-described rotational shaft located on the upstream side in the flow direction of exhaust gas that flows through the wheel. According to this kind of configuration, there is a possibility that, since a high-temperature exhaust gas that has passed through this wheel passes through the vicinity of a bearing that supports the rotational shaft, the temperature of the bearing may increase.

### SUMMARY

In order to rotationally drive a compressor, an internal combustion engine may be equipped with a turbocharger that includes an axial flow turbine. In this turbocharger, a compressor impeller of the compressor and a turbine wheel of the axial flow turbine are coupled to each other through a rotational shaft. In this kind of turbocharger, the turbine wheel may be coupled to the rotational shaft such that an outlet of turbine blades of the turbine wheel is located on the side of the compressor impeller. However, there is a concern that, if the turbine wheel is arranged in this way without any special considerations, the temperature of a bearing that supports the rotational shaft may increase similarly to the configuration disclosed in JP 2017-145748 A.

In order to avoid the temperature increase of the bearing, the turbine wheel may be coupled to the rotational shaft such that, contrary to the above, the inlet of the turbine blades is located on the side of the compressor impeller. However, if this kind of configuration is adopted, in order to introduce exhaust gas into the inlet of the turbine blades located between the compressor impeller and the turbine wheel, it is required to include a scroll portion formed at a location of an exhaust gas passage on the upstream side of the turbine blades. Shortening of the distance from a cylinder to the inlet of the turbine blades is effective to increase the energy of the exhaust gas that flows into the turbine wheel. However, forming the scroll portion described above impedes the shortening of the distance from the cylinder to the inlet of the turbine blades.

The present disclosure has been made to address the problem described above, and an object of the present disclosure is to provide an internal combustion engine equipped with a turbocharger including an axial flow turbine wheel, which can favorably achieve both reduction of temperature increase of a bearing and increase of energy of exhaust gas flowing into the turbine wheel.

An internal combustion engine according to the present disclosure includes: an exhaust gas passage through which exhaust gas discharged from a cylinder flows; a water-cooled cylinder head; a turbocharger. The turbocharger includes: a compressor impeller; an axial flow turbine wheel coupled to the compressor impeller through a rotational shaft; a bearing that supports a portion of the rotational shaft located between the compressor impeller and the turbine wheel; and a housing that houses at least the compressor impeller and the bearing among the compressor impeller, the bearing and the turbine wheel. The turbine wheel is coupled to the rotational shaft such that an outlet of turbine blades of the turbine wheel is located on a side of the compressor impeller. The housing is fastened to the cylinder head, directly or with a first gasket interposed between the housing and the cylinder head, such that the turbine wheel is opposed to the cylinder head.

An inlet of the turbine blades may be arranged on an upstream side of an exhaust gas flow relative to a fastening surface of the housing with respect to the cylinder head.

The exhaust gas passage may include a cylinder-head-inner gas passage formed inside the cylinder head. Also, the turbine wheel may be arranged in the cylinder-head-inner gas passage.

A peripheral surface of the cylinder-head-inner gas passage may be opposed to the turbine blades in a radial direction of the turbine wheel.

The housing may include a turbine housing portion that covers the turbine wheel. At least a part of the turbine housing portion may be inserted into the cylinder-head-inner gas passage. Furthermore, an inner peripheral surface of the turbine housing portion may be opposed to the turbine blades in a radial direction of the turbine wheel.

The internal combustion engine may further include a second gasket arranged between the cylinder-head-inner gas passage and the turbine wheel. Also, an inner peripheral surface of the second gasket may be opposed to the turbine blades in a radial direction of the turbine wheel.

The housing may include a bearing housing portion that houses the bearing. Also, the bearing housing portion may be fastened to the cylinder head directly or with the first gasket interposed between the bearing housing portion and the cylinder head.

The internal combustion engine may further include an exhaust gas purifying catalyst arranged in a portion of the exhaust gas passage located on a downstream side of the turbine wheel. Also, the exhaust gas passage may include a catalyst upstream passage configured to connect the outlet of the turbine blades and the exhaust gas purifying catalyst. Furthermore, at least a part of the catalyst upstream passage may be formed inside the cylinder head.

The turbocharger further may include a nozzle arranged at a portion of the exhaust gas passage located on a downstream side of the turbine wheel. Also, the nozzle may be formed such that a cross-sectional area of the nozzle gradually becomes greater as the exhaust gas flows downstream.

According to the internal combustion engine of the present disclosure, the axial flow turbine wheel is coupled to the rotational shaft such that the outlet of the turbine blades is located on the side of the compressor impeller. Because of this, contrary to a radial turbine, it is not required to include a scroll portion located on the inlet side of the turbine blades. Therefore, the distance from the cylinder to the inlet of the turbine blades can be shortened. As a result, the energy of the exhaust gas flowing into the turbine wheel can be increased. Moreover, according to the internal combustion engine of the present disclosure, the housing is fastened to the cylinder head, directly or with the first gasket interposed between the housing and the cylinder head, such that the turbine wheel is opposed to the cylinder head. Thus, the heat that transmits to the housing from a high-temperature exhaust gas flowing out from the turbine blades can be released to the wall-cooled cylinder head. Therefore, according to the internal combustion engine of the present disclosure, reduction of temperature increase of the bearing and increase of the energy of the exhaust gas flowing into the turbine can be both favorably achieved.

### BRIEF DESCRIPTION OF THE DRAWINGS

FIG. 1 is a diagram that schematically illustrates the configuration of a main part of an internal combustion engine according to a first embodiment of the present disclosure;

FIG. 2 is a diagram that schematically illustrates the configuration of a main part of an internal combustion engine according to a second embodiment of the present disclosure;

FIG. 3 is a diagram that schematically illustrates the configuration of a main part of an internal combustion engine according to a third embodiment of the present disclosure;

FIG. 4 is a diagram that schematically illustrates the configuration of a main part of an internal combustion engine according to a fourth embodiment of the present disclosure;

FIG. 5 is a diagram that schematically illustrates the configuration of a main part of an internal combustion engine according to a fifth embodiment of the present disclosure;

FIG. 6 is a diagram that schematically illustrates the configuration of a main part of an internal combustion engine according to a sixth embodiment of the present disclosure;

FIG. 7 is a diagram that schematically illustrates the configuration of the main part of the internal combustion engine according to the sixth embodiment of the present disclosure; and

FIG. 8 is a diagram that schematically illustrates the configuration of a main part of an internal combustion engine according to a seventh embodiment of the present disclosure.

### DETAILED DESCRIPTION

In embodiments of the present disclosure which will be described later, elements that are the same as each other in the drawings are denoted by the same reference symbols, and redundant descriptions of those elements will be omitted or simplified. Moreover, it is to be understood that even when the number, quantity, amount, range or other numerical attribute of an element is mentioned in the following description of the embodiments, the present disclosure is not limited to the mentioned numerical attribute unless explicitly described otherwise, or unless the present disclosure is explicitly specified by the numerical attribute theoretically. Furthermore, structures or the like that are described in conjunction with the following embodiments are not necessarily essential to the present disclosure unless explicitly shown otherwise, or unless the present disclosure is explicitly specified by the structures or the like theoretically.

### 1. First Embodiment

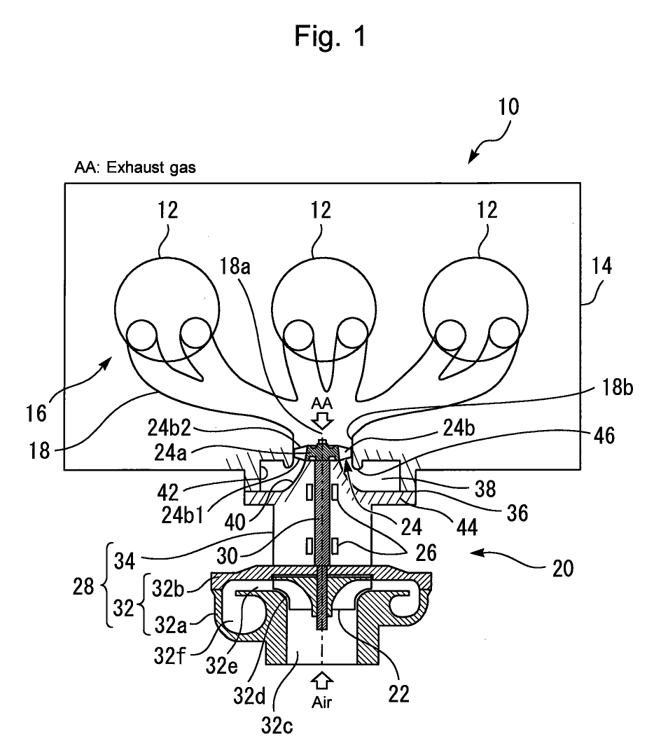

Firstly, a first embodiment according to the present disclosure will be described with reference to FIG. 1.

### 1-1. Configuration of Main Part of Internal Combustion Engine

FIG. 1 is a diagram that schematically illustrates the configuration of a main part of an internal combustion engine 10 according to the first embodiment of the present disclosure. The internal combustion engine 10 shown in FIG. 1 is, as an example, an in-line three-cylinder engine having three cylinders 12. The internal combustion engine 10 is equipped with a cylinder head 14. The cylinder head 14 forms the three cylinders 12 in association with a cylinder block (not shown). It should be noted that the number and arrangement of cylinders of the internal combustion engine according to the present disclosure are not particularly limited.

A cooling water passage (not shown) through which engine cooling water flows is formed in the cylinder head 14. That is to say, the cylinder head 14 is water-cooled type. Also, the internal combustion engine 10 is provided with an exhaust gas passage 16 through which exhaust gas discharged from each cylinder 12 flows. The exhaust gas passage 16 includes a cylinder-head-inner gas passage 18 formed inside the cylinder head 14 as shown in FIG. 1. The cylinder-head-inner gas passage 18 is formed so as to making exhaust gases from the respective cylinders 12 converge into one flow. In other words, in the internal combustion engine 10, an exhaust manifold is integrated with the cylinder head 14. It should be noted that the cylinder head 14 is configured by a metal material (for example, aluminum alloy).

The internal combustion engine 10 is equipped with a turbocharger 20. The turbocharger 20 includes a compressor impeller 22, an axial flow turbine wheel 24, bearings 26 and a housing 28. It should be noted that the housing 28 is configured by a metal material (for example, iron).

To be more specific, the turbine wheel 24 is coupled to the compressor impeller 22 through a rotational shaft 30. The bearings 26 support the rotational shaft 30 at, for example, portions located between the compressor impeller 22 and the turbine wheel 24 (in the example shown in FIG. 1, two portions). In addition, the number of “bearings” according to the present disclosure is not limited to two, and may be one or three or more. The housing 28 includes a compressor housing portion 32 that houses the compressor impeller 22 and a bearing housing portion 34 that houses the two bearings 26. The compressor housing portion 32 and the bearing housing portion 34 are adjacent to each other.

The compressor housing portion 32 forms, with a pair of housing pieces 32a and 32b, the compressor inlet portion 32c, an impeller portion 32d, a diffuser portion 32e and a scroll portion 32f. A compressor of, for example, the centrifugal type for supercharging intake air of the internal combustion engine 10 is configured with this compressor housing portion 32 and the compressor impeller 22.

The turbine wheel 24 includes a rotor disc 24a and a plurality of turbine blades (i.e., rotor blades) 24b. The rotor disc 24a is coupled to the rotational shaft 30. The plurality of turbine blades 24b are formed integrally with the rotor disc 24a such that they extend outward in the radial direction from the rotor disc 24a.

As shown in FIG. 1, the turbine wheel 24 is coupled to the rotational shaft 30 such that an outlet 24b1 of the turbine blades 24b is located at the side of the compressor impeller 22. Also, the housing 28 is directly fastened to the cylinder head 14, using a fastener (not shown), such as bolt, such that (the inlet 24b2 of the turbine blades 24b of) the turbine wheel 24 is opposed to the cylinder head 14.

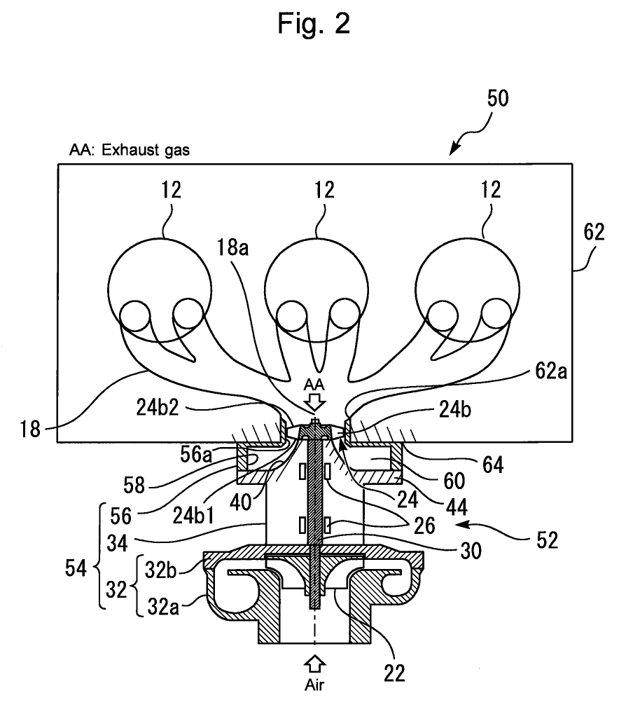

To be more specific, according to the example shown in FIG. 1, the bearing housing portion 34 included in components of the housing 28 is directly fastened to the cylinder head 14. It should be noted that, in FIG. 1, the respective portions of the cylinder head 14 and bearing housing portion 34 located around the turbine wheel 24 with hatching indicate cross-sections of the cylinder head 14 and bearing housing portion 34 at the center position of the rotational shaft 30. This also applies to FIGS. 2-6 and 8 described later.

Moreover, as shown in FIG. 1, according to the internal combustion engine 10, the inlet 24b2 of the turbine blades 24b is arranged at the upstream side of the exhaust gas flow relative to the fastening surface 36 of the bearing housing portion 34 with respect to the cylinder head 14. Also, the turbine wheel 24 is arranged in the cylinder-head-inner gas passage 18. To be more specific, the turbine wheel 24 is arranged at a collective portion 18a of the cylinder-head-inner gas passage 18, and the peripheral surface 18b of the cylinder-head-inner gas passage 18 is opposed to the turbine blades 24b in the radial direction of the turbine wheel 24. In other words, the turbine blades 24b (turbine wheel 24) form a clearance with the peripheral surface 18b.

According to the internal combustion engine 10 of the present embodiment, a turbine outlet passage 38 that is an outlet passage of the turbine wheel 24 is formed, with a structure as described below, using the wall surface of the bearing housing portion 34 and the wall surface of the cylinder head 14.

Specifically, a turbine outlet wall portion 40 of the bearing housing portion 34 is formed at a location closer to the outlet 24b1 of the turbine blades 24b in the axial direction of the rotational shaft 30. The turbine outlet wall portion 40 is formed such that the diameter thereof becomes greater at a location farther away from the outlet 24b1 of the turbine blades 24b in the axial direction of the rotational shaft 30 (i.e., in other words, formed in a substantially frusto-conical shape). The cylinder head 14 includes a scroll portion 42 formed so as to cover this turbine outlet wall portion 40. Also, the bearing housing portion 34 includes a flange portion 44 formed so as to extend in the radial direction of the rotational shaft 30. In more detail, the fastening between the cylinder head 14 and the bearing housing portion 34 are made between an end surface of this scroll portion 42 and the flange portion 44. That is to say, a part of this flange portion 44 corresponds to the fastening surface 36 described above.

The turbine outlet passage 38 is configured by the scroll portion 42 and the flange portion 44 in addition to the turbine outlet wall portion 40. The scroll portion 42 has a scroll shape in order to change the flow direction of the exhaust gas that has flown out from the outlet 24b1 of the turbine blades 24b. To be more specific, the scroll portion 42 has a scroll shape that centers on the rotational shaft 30 and is formed such that the flow passage cross-sectional area gradually becomes greater at a location farther away from the outlet 24b1. The flow passage cross-sectional area of a portion of the turbine outlet passage 38 located on the right side of the sheet of FIG. 1 relative to the turbine outlet wall portion 40 is depicted so as to be greater than that of a portion located on the left side of the sheet. That is to say, the portion on the right side of the sheet is located on the downstream side of the exhaust gas flow as compared to the portion on the left side of the sheet. In addition, the turbine outlet passage 38 configured as described above corresponds to a part of the exhaust gas passage 16.

It should be noted that, according to the present embodiment, an end portion (not shown) of the scroll portion 42 located on the downstream side of the exhaust gas flow is arranged outside the cylinder head 14, as an example. An exhaust pipe that forms a portion of the exhaust gas passage 16 located on the downstream side of the turbocharger 20 is connected to this end portion. In addition, an annular protrusion 46 that is formed in the scroll portion 42 at a portion near the outlet 24b1 of the turbine blades 24b is arranged to smooth the exhaust gas flow flowing out from the outlet 24b1. In more detail, if a flow passage is abruptly enlarged, the flow loss increases. In order not to increase this kind of flow loss, the annular protrusion 46 is formed so as to be able to gradually increase the flow passage cross-sectional area.

Additionally, in the example shown in FIG. 1, function of a turbine housing that houses the turbine wheel 24 is achieved by the use of the cylinder head 14 (more specifically, a peripheral surface 18b of the cylinder-head-inner gas passage 18 and the scroll portion 42). Also, the turbine outlet passage 38 is configured by the bearing housing portion 34 (i.e., the turbine outlet wall portion 40 and the flange portion 44) and the scroll portion 42 as described above. Thus, according to the internal combustion engine 10, an axial flow turbine that rotationally drives the compressor impeller 22 is configured with the turbine wheel 24, the peripheral surface 18b and scroll portion 42 of the cylinder head 14, and the bearing housing portion 34 (i.e., the turbine outlet wall portion 40 and the flange portion 44).

### 1-2. Advantageous Effects

### 1-2-1. Increase of Energy of Exhaust Gas Flowing into Turbine

It is required for an internal combustion engine equipped with a turbocharger using a radial turbine to include a scroll portion located on the inlet side of turbine blades and a pipe connecting the scroll portion with a portion of an exhaust gas passage located on the upstream side of the scroll portion. In contrast to this, the internal combustion engine 10 according to the present embodiment is equipped with the turbocharger 20 having the axial flow turbine wheel 24 that is arranged such that the outlet 24b1 of the turbine blades 24b is located on the side of the compressor impeller 22. Because of this, contrary to the radial turbine, it is not required to include a scroll portion located on the inlet 24b2 side of the turbine blades 24b, and the above-described pipe thus becomes unnecessary. Therefore, the distance from each cylinder 12 to the inlet 24b2 of the turbine blades 24b can be shortened. As a result, the surface area of a portion of the exhaust gas passage located on the upstream side of the turbine blades 24b is reduced, whereby a decrease of the temperature of the exhaust gas that flows into the turbine blades 24b can be reduced. Also, the volume of the portion of the exhaust gas passage located on the upstream side of the turbine wheel 24 is reduced, whereby a decrease of the pressure of the exhaust gas that flows into the turbine wheel 24 can be reduced. As just described, according to the present embodiment, the configuration that can effectively increase the energy of the exhaust gas that flows into the turbine wheel 24 is achieved due to the shortening of the distance described above.

In addition, according to the internal combustion engine 10, the turbine wheel 24 is arranged in the cylinder-head-inner gas passage 18. This can more sufficiently achieve advantageous effects of increase of the exhaust energy supplied to the turbine wheel 24 due to the shortening of the distance described above.

### 1-2-2. Reduction of Temperature Increase of Bearings

By the use of the axial flow turbine wheel 24 arranged such that the outlet 24b1 of the turbine blades 24b is located on the side of the compressor impeller 22, as described above, the energy of the exhaust gas that flows into the turbine can be increased as compared to the example of the radial turbine. However, as a trade-off, a high-temperature exhaust gas that has passed through the turbine blades 24b flows around the bearing housing portion 34 toward the side of the compressor impeller 22 (i.e., the side of the bearings 26 located between the turbine wheel 24 and the compressor impeller 22). Because of this, there is a possibility that, if proper measures are not taken, the temperature of the bearings 26 may increase.

In terms of the above-described issue, according to the present embodiment, the housing 28 of the turbocharger 20 is directly fastened to the cylinder head 14 such that (the inlet 24b2 of the turbine blades 24b of) the turbine wheel 24 is opposed to the water-cooled cylinder head 14. Thus, the heat that transmits to the housing 28 from a high-temperature exhaust gas flowing out from the turbine blades 24b can be released to a low-temperature cylinder head 14. Therefore, according to the internal combustion engine 10 of the present embodiment, reduction of temperature increase of the bearings 26 and increase of energy of the exhaust gas flowing into the turbine wheel 24 can be both favorably achieved. Moreover, due to the reduction of temperature increase of the bearings 26, the degradation of the oil that lubricates the bearings 26 can be reduced.

In addition, what is directly fastened to the cylinder head 14 in the present embodiment is the bearing housing portion 34 that houses the bearings 26. Therefore, according to the present configuration, the heat that transmits to the bearing housing portion 34 from a high-temperature exhaust gas flowing out from the turbine blades 24b can be effectively released to the cylinder head 14. Moreover, as a result of the heat dissipation of the bearing housing portion 34 being effectively improved in this way, the following advantageous effects can also be achieved. That is to say, in order to improve the heat dissipation of the bearing housing portion, a configuration to introduce the engine cooling water with respect to the bearing housing portion 34 may be additionally adopted. In this kind of configuration, if the internal combustion engine 10 is stopped, circulation of the engine cooling water is stopped. Thus, there is a concern that the temperature of the bearing housing portion 34 may increase after the engine stop. In this regard, due to the fact that the heat dissipation of the bearing housing portion 34 can be improved using the fastening manner described above, the temperature increase of the bearing housing portion 34 after the engine stop can also be effectively reduced.

### 1-2-3. Reduction of Thermal Radiation to Turbine Blades

Moreover, according to the internal combustion engine 10 of the present embodiment, the inlet 24b2 of the turbine blades 24b is arranged on the upstream side of the fastening surface 36 of the bearing housing portion 34 with respect to the cylinder head 14 in the exhaust gas flow direction. According to this kind of arrangement, the turbine blades 24b are installed at a portion near the wall surface of the cylinder head 14 cooled by engine cooling water. It can thus be said that the temperature of the wall surface of passage of the exhaust gas located upstream of the turbine blades 24b becomes lower as compared to an example in which the turbine blades 24b are arranged outside the cylinder head 14. As a result, since the inflow of heat by the thermal radiation to the turbine blades 24b from the wall surface of the passage is reduced, an increase of the temperature of the rotational shaft 30 coupled to the turbine wheel 24 due to the thermal radiation described above is reduced. This leads to reduction of increase of the temperature of the bearings 26. In addition, due to the reduction of the inflow of heat by the thermal radiation, an increase of the clearance between the turbine blades 24b and the peripheral surface 18b of the cylinder-head-inner gas passage 18 can be reduced when the exhaust gas temperature is high.

Additionally, according to the internal combustion engine 10 of the present embodiment, the turbine wheel 24 is arranged in the cylinder-head-inner gas passage 18. More specifically, according to this turbine wheel 24, the turbine blades 24b are opposed to the peripheral surface 18b of the cylinder-head-inner gas passage 18 in the radial direction of the turbine wheel 24. With this kind of configuration, the effects of reduction of the thermal radiation described above can be more effectively achieved.

### 1-2-4. Advantageous Effects Concerning Shape of Turbine Outlet Wall Portion

Furthermore, as described above, the turbine outlet wall portion 40 located immediately downstream of the turbine wheel 24 is formed such that the diameter of the turbine outlet wall portion 40 becomes greater at a location farther away from the outlet 24b1 of the turbine blades 24b in the axial direction of the rotational shaft 30 (i.e., in other words, formed in a substantially frusto-conical shape). If, contrary to this kind of shape, the turbine outlet wall portion is formed in a cylindrical shape, the exhaust gas that has flown out from the turbine blades 24b flows in such a manner as to collide with the bearing housing portion. In contrast to this, the turbine outlet wall portion 40 having the shape according to the present embodiment can improve the flow of the exhaust gas immediately downstream of the turbine wheel 24. Moreover, the bearings 26 can be separated from the wall surface of the turbine outlet passage 38 as compared to the example of the cylindrical shape described above, whereby increase of the temperature of the bearings 26 can be more effectively reduced due to an enlargement of heat transfer distance.

### 2. Second Embodiment

Next, a second embodiment according to the present disclosure will be described with reference to FIG. 2.

### 2-1. Configuration of Main Part of Internal Combustion Engine

FIG. 2 is a diagram that schematically illustrates the configuration of a main part of an internal combustion engine 50 according to the second embodiment of the present disclosure. The internal combustion engine 50 according to the present embodiment is different from the internal combustion engine 10 according to the first embodiment in terms of the configuration around the turbine wheel 24.

As shown in FIG. 2, the internal combustion engine 50 is equipped with a turbocharger 52. The turbocharger 52 is different from the turbocharger 20 shown in FIG. 1 in terms of the configuration of a housing 54. In detail, the housing 54 includes a turbine housing portion 56 as well as the compressor housing portion 32 and the bearing housing portion 34. The turbine housing portion 56 is formed so as to cover not only the turbine wheel 24 but also the turbine outlet wall portion 40.

The turbine housing portion 56 is adjacent to the bearing housing portion 34. The turbine housing portion 56 includes a scroll portion 58 that is formed similarly to the scroll portion 42 shown in FIG. 1. That is to say, according to the present embodiment, a turbine outlet passage 60 is configured with this scroll portion 58 as well as the turbine outlet wall portion 40 and the flange portion 44.

According to the present embodiment, the turbine housing portion 56 of the housing 54 is directly fastened to a cylinder head 62 using a fastener (not shown), such as bolts, such that (the inlet 24b2 of the turbine blades 24b of) the turbine wheel 24 is opposed to the cylinder head 62.

Moreover, according to the internal combustion engine 50 shown in FIG. 2, the inlet 24b2 of the turbine blades 24b is arranged at the upstream side of the exhaust gas flow relative to a fastening surface 64 of the turbine housing portion 56 with respect to the cylinder head 62. Also, similarly to the example of the internal combustion engine 10, the turbine wheel 24 is arranged in the cylinder-head-inner gas passage 18. To be more specific, a portion of the turbine housing portion 56 (i.e., a portion that covers the turbine wheel 24) is inserted into a peripheral surface 62a (of the collective portion 18a) of the cylinder-head-inner gas passage 18. Also, an inner peripheral surface 56a of the turbine housing portion 56 that is into contact with this peripheral surface 62a is opposed to the turbine blades 24b in the radial direction of the turbine wheel 24. In other words, the turbine blades 24b (i.e., turbine wheel 24) form a clearance with the inner peripheral surface 56a.

### 2-2. Advantageous Effects

According to the internal combustion engine 50 of the present embodiment that includes the turbine housing portion 56 described above, reduction of temperature increase of the bearings 26 and increase of the energy of the exhaust gas flowing into the turbine wheel 24 can be both favorably achieved similarly to the first embodiment. However, in terms of heat release into a cylinder head from a bearing housing portion that houses the bearings 26, it can be said that the internal combustion engine 10 without the turbine housing portion 56 interposed between the cylinder head 62 and the bearing housing portion 34 is superior to the internal combustion engine 50 with this kind of turbine housing portion 56 interposed therebetween.

Furthermore, according to the internal combustion engine 50 of the present embodiment, the turbine wheel 24 (i.e., the turbine blades 24b) is not directly opposed to the peripheral surface 62a of the cylinder head 62 in the radial direction of the turbine wheel 24, and is instead opposed to the inner peripheral surface 56a of the turbine housing portion 56. According to this kind of configuration, since the turbine housing portion 56 is cooled by the water-cooled cylinder head 62, the inflow of heat due to the thermal radiation into the turbine blades 24b from the turbine housing portion 56 is reduced. Because of this, temperature increase of the rotational shaft 30 due to the thermal radiation and temperature increase of the bearings 26 based thereon can be reduced.

### 2-3. Modification Examples

In the second embodiment described above, the turbine housing portion 56 is configured such that a part of the turbine housing portion 56 is inserted into the cylinder-head-inner gas passage 18. However, in another example of the turbine housing portion according to the present disclosure, the whole turbine housing portion may be inserted into the cylinder-head-inner gas passage.

Furthermore, according to the example of the internal combustion engine 50 shown in FIG. 2, the inlet 24b2 of the turbine blades 24b is arranged on the upstream side of the exhaust gas flow relative to the fastening surface 64, and the turbine wheel 24 is arranged in the cylinder-head-inner gas passage 18. Instead of this kind of example, the shape of the turbine housing portion may be changed such that the turbine wheel 24 is not arranged in the cylinder-head-inner gas passage 18, while the inlet 24b2 of the turbine blades 24b is arranged on the upstream side of the exhaust gas flow relative to the fastening surface 64.

### 3. Third Embodiment

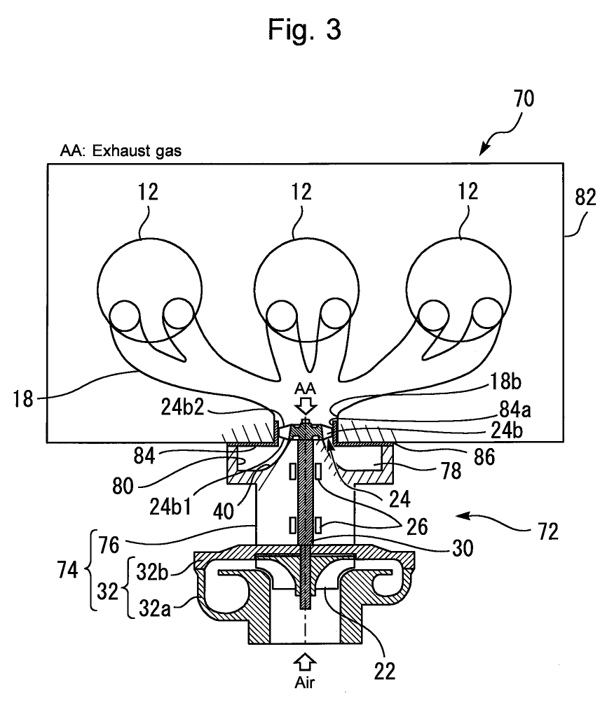

Next, a third embodiment according to the present disclosure will be described with reference to FIG. 3.

### 3-1. Configuration of Main Part of Internal Combustion Engine

FIG. 3 is a diagram that schematically illustrates the configuration of a main part of an internal combustion engine 70 according to the third embodiment of the present disclosure. The internal combustion engine 70 according to the present embodiment is different from the internal combustion engine 10 according to the first embodiment in terms of the configuration around the turbine wheel 24.

As shown in FIG. 3, the internal combustion engine 70 is equipped with a turbocharger 72. The turbocharger 72 is different from the turbocharger 20 shown in FIG. 1 in terms of the configuration of a housing 74. In detail, the housing 74 includes a bearing housing portion 76 as well as the compressor housing portion 32.

According to the example shown in FIG. 1, the turbine outlet wall portion 40 is covered by the scroll portion 42 that is formed so as to extend toward the bearing housing portion 34 from the cylinder head 14. In contrast to this, according to the example shown in FIG. 3, a scroll portion 80 for forming a turbine outlet passage 78 is formed in the bearing housing portion 76. Because of this, the turbine outlet wall portion 40 shown in FIG. 3 is covered by the scroll portion 80 that is formed so as to extend toward a cylinder head 82 from the bearing housing portion 76.

Also, according to the present embodiment, the scroll portion 80 of the bearing housing portion 76 is fastened to the cylinder head 82 with a gasket 84 interposed therebetween. Thus, the gasket 84 corresponds to an example of the “first gasket” according to the present disclosure. In addition, according to the present embodiment, the turbine outlet passage 78 is configured with the turbine outlet wall portion 40 and scroll portion 80, and also the cylinder head 82 (more specifically, the gasket 84).

Moreover, according to the internal combustion engine 70 shown in FIG. 3, similarly to the internal combustion engine 10, the inlet 24b2 of the turbine blades 24b is arranged on the upstream side of the exhaust gas flow relative to a fastening surface 86 of the bearing housing portion 76 with respect to the cylinder head 82.

Furthermore, similarly to the example of the internal combustion engine 10, the turbine wheel 24 is arranged in the cylinder-head-inner gas passage 18. That is to say, the function of the turbine housing that houses the turbine wheel 24 is achieved by the use of the cylinder head 82.

In addition, the gasket 84 interposed between the cylinder head 82 and the bearing housing portion 76 extends to a portion located between the peripheral surface 18b of the cylinder-head-inner gas passage 18 and the turbine wheel 24. Thus, the gasket 84 also corresponds to an example of the “second gasket” according to the present disclosure. To be more specific, an inner peripheral surface 84a of the gasket 84 is opposed to the turbine blades 24b in the radial direction of the turbine wheel 24. In other words, the turbine blades 24b (turbine wheel 24) forms a clearance with the inner peripheral surface 84a of the gasket 84. It should be noted that, instead of the example of the gasket 84 described above, the gasket opposed to the fastening surface 86 may be separately provided with a gasket arranged on the peripheral surface 18b, or any one of these gaskets may alternatively be omitted.

### 3-2. Advantageous Effects

According to the internal combustion engine 70 of the present embodiment having the configuration described above, similarly to the first and second embodiments, reduction of temperature increase of the bearings 26 and increase of the energy of the exhaust gas flowing into the turbine wheel 24 can be both favorably achieved. However, in terms of heat dissipation to the cylinder head from the bearing housing portion that houses the bearings 26, it can be said that the internal combustion engine 10 without the gasket 84 interposed between the cylinder head 82 and the bearing housing portion 76 is superior to the internal combustion engine 70 with this kind of gasket 84 interposed therebetween.

Furthermore, according to the internal combustion engine 50 of the present embodiment, the turbine wheel 24 (i.e., the turbine blades 24b) is not directly opposed to the peripheral surface 62a of the cylinder head 62 in the radial direction of the turbine wheel 24, and is instead opposed to the inner peripheral surface 84a of the gasket 84. According to this kind of configuration, since the gasket 84 is cooled by the wall-cooled cylinder head 82, the inflow of heat by the thermal radiation to the turbine blades 24b from the gasket 84 is reduced. Because of this, temperature increase of the rotational shaft 30 due to the thermal radiation and temperature increase of the bearings 26 based thereon can be reduced.

### 4. Fourth Embodiment

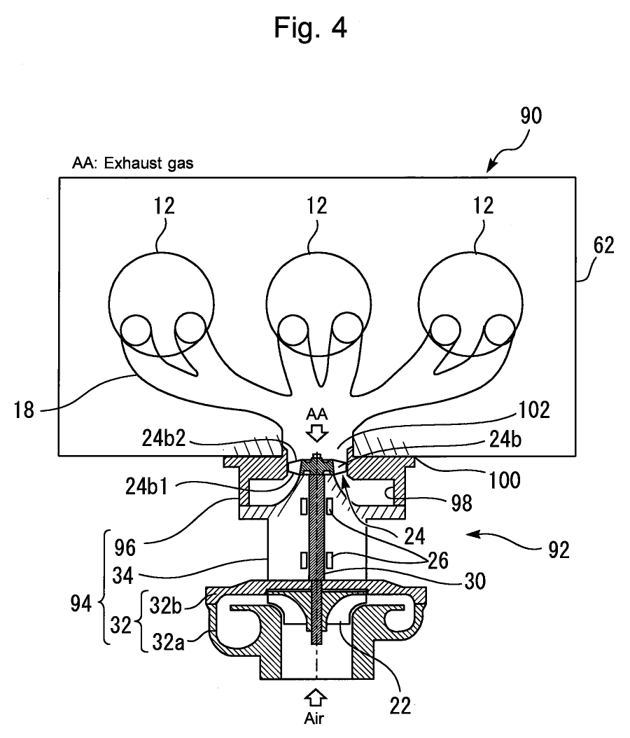

Next, a fourth embodiment according to the present disclosure will be described with reference to FIG. 4.

### 4-1. Configuration of Main Part of Internal Combustion Engine

FIG. 4 is a diagram that schematically illustrates the configuration of a main part of an internal combustion engine 90 according to the fourth embodiment of the present disclosure. The internal combustion engine 90 according to the present embodiment is different from the internal combustion engine 50 according to the second embodiment in terms of the configuration around the turbine wheel 24.

As shown in FIG. 4, the internal combustion engine 90 is equipped with a turbocharger 92. A housing 94 of the turbocharger 92 includes a turbine housing portion 96 as well as the compressor housing portion 32 and the bearing housing portion 34, similarly to the turbocharger 52 shown in FIG. 2.

Similarly to the turbine housing portion 56 shown in FIG. 2, the turbine housing portion 96: is configured such that the outlet 24b1 of the turbine blades 24b covers the turbine wheel 24 that is arranged so as to be located on the side of the compressor impeller 22; is directly fastened to the cylinder head 62 such that (the inlet 24b2 of the turbine blades 24b of) the turbine wheel 24 is opposed to the wall-cooled cylinder head 62; and includes a scroll portion 98 similar to the scroll portion 58. On that basis, due to the difference of the shape between the turbine housing portion 96 and the turbine housing portion 56, the installation location of the turbine wheel 24 is different from that in the example shown in FIG. 2 in the following points.

That is to say, according to the internal combustion engine 90 shown in FIG. 4, the inlet 24b2 of the turbine blades 24b is not arranged on the upstream side of the exhaust gas flow relative to a fastening surface 100 of the turbine housing portion 96 with respect to the cylinder head 62, and is instead arranged on the downstream side thereof. Also, the turbine wheel 24 is not arranged in the cylinder-head-inner gas passage 18, and is instead arranged in a gas passage 102 in the turbine housing portion 96 located on the downstream side thereof (i.e., located outside the cylinder head 62).

### 4-2. Advantageous Effects

According to the internal combustion engine 90 of the present embodiment having the turbine housing portion 96 described above, the turbine wheel 24 is also arranged such that the outlet 24b1 of the turbine blades 24b is located on the side of the compressor impeller 22. In addition, the turbine housing portion 96 is directly fastened to the cylinder head 62 such that (the inlet 24b2 of the turbine blades 24b of) the turbine wheel 24 is opposed to the water-cooled cylinder head 14. Because of this, similarly to the first to third embodiments, reduction of temperature increase of the bearings 26 and increase of the energy of the exhaust gas flowing into the turbine wheel 24 can be both favorably achieved.

### 5. Fifth Embodiment

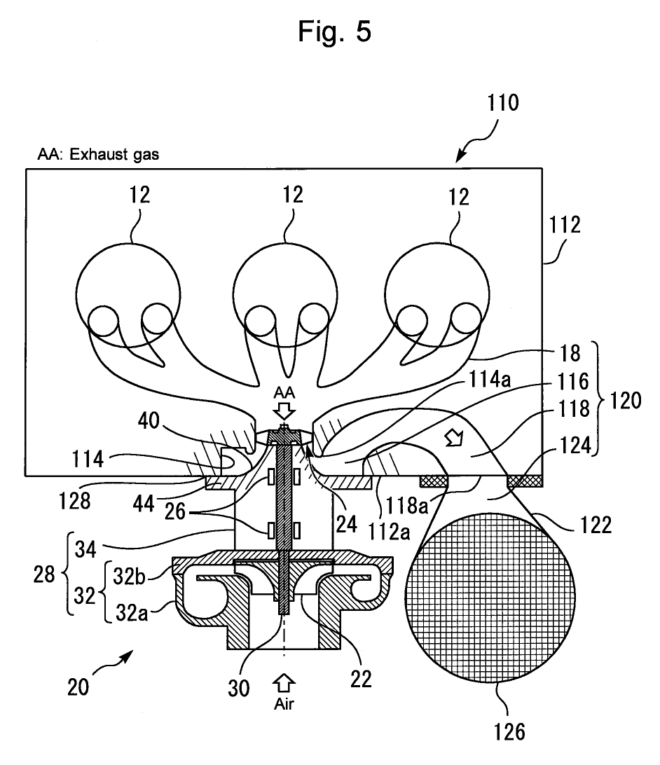

Next, a fifth embodiment according to the present disclosure will be described with reference to FIG. 5.

### 5-1. Configuration of Main Part of Internal Combustion Engine

FIG. 5 is a diagram that schematically illustrates the configuration of a main part of an internal combustion engine 110 according to the fifth embodiment of the present disclosure. The internal combustion engine 110 according to the present embodiment is different from the internal combustion engine 10 according to the first embodiment mainly in terms of the configuration of a portion of the exhaust gas passage located on the outlet side of the turbine outlet passage (i.e., scroll portion).

Specifically, as shown in FIG. 5, a cylinder head 112 of the internal combustion engine 110 is provided with a scroll portion 114. Although the shape of this scroll portion 114 is different from that of the scroll portion 42 shown in FIG. 1, the scroll portion 114 forms a turbine outlet passage 116 in association with the turbine outlet wall portion 40 and the flange portion 44, similarly to the scroll portion 42.

According to the internal combustion engine 10 of the first embodiment, the end portion of the scroll portion 42 located on the downstream side of the exhaust gas flow is arranged outside the cylinder head 14. In contrast to this, according to the internal combustion engine 110 of the present embodiment, an end portion 114a of the scroll portion 114 located on the downstream side of the exhaust gas flow is located inside the cylinder head 112 as shown in FIG. 5. Also, a cylinder-head-inner gas passage 118 that is formed in the cylinder head 112 is connected with this end portion 114a. The cylinder-head-inner gas passage 118 is included in an exhaust gas passage 120 of the internal combustion engine 110 as well as the cylinder-head-inner gas passage 18 and the turbine outlet passage 116.

An end portion 118a of the cylinder-head-inner gas passage 118 located on the downstream side thereof opens to an outer surface 112a of the cylinder head 112 at a side surface of the cylinder head 112. An exhaust gas pipe 122 is connected with this end portion 118a. A cylinder-head-outer gas passage 124 included in the exhaust gas passage 120 also corresponds to a part of the exhaust gas passage 120. Moreover, an exhaust gas purifying catalyst 126 for purifying the exhaust gas is installed in the exhaust gas pipe 122. Furthermore, a reference numeral 128 indicates a fastening surface of the bearing housing portion 34 with respect to the cylinder head 112.

It should be noted that, according to the present embodiment, the cylinder-head-inner gas passage 118 and a portion of the cylinder-head-outer gas passage 124 located on the upstream side of the exhaust gas purifying catalyst 126 correspond to an example of the “catalyst upstream passage” according to the present disclosure. In addition, the cylinder-head-inner gas passage 118 also corresponds to an example of the “cylinder-head-inner gas passage” according to the present disclosure.

### 5-2. Advantageous Effects

As described so far, according to the internal combustion engine 110 of the present embodiment, an upstream portion (i.e., the cylinder-head-inner gas passage 118) among portions of the exhaust gas passage 120 that connects the turbine outlet passage 116 with the exhaust gas purifying catalyst 126 is formed inside the cylinder head 112. On the other hand, according to the internal combustion engine 10 (see FIG. 1) in which this upstream portion is formed inside an exhaust gas pipe located outside the cylinder head 14, this exhaust gas pipe receives heat from a high-temperature exhaust gas discharged from the turbine outlet passage 38. In addition, the bearing housing portion 34 that houses the bearings 26 is located near this exhaust gas pipe. Thus, this bearing housing portion 34 receives heat from the exhaust gas pipe. In this regard, according to the internal combustion engine 110 of the present embodiment, a portion of the exhaust gas passage 120 that is connected with the turbine outlet passage 116 is the cylinder-head-inner gas passage 118 of the water-cooled cylinder head 112. Moreover, the exhaust gas pipe 122 located outside the cylinder head 112 is arranged on the downstream side of the end portion of the turbine outlet passage 116 (i.e., the end portion 114a of the scroll portion 114). As a result, the temperature of the exhaust gas that flows into the exhaust gas pipe 122 becomes lower than the temperature of the exhaust gas that flows out from the end portion 114a. Because of this, according to the configuration of the present embodiment, the heat received by the bearing housing portion 34 from the exhaust gas pipe 122 can be reduced, and temperature increase of the bearings 26 can thus be reduced more effectively.

### 5-3. Modification Examples

In the example of the “catalyst upstream passage” according to the fifth embodiment described above, the cylinder-head-inner gas passage 118 that corresponds to a part of the catalyst upstream passage is arranged inside the cylinder head 112. However, in another example of the “catalyst upstream passage” according to the present disclosure, the whole catalyst upstream passage may be arranged inside the cylinder head 112. That is to say, a configuration in which an exhaust gas purifying catalyst is directly attached to an opening portion of the catalyst upstream passage that is formed on the outer surface of the cylinder head 112 may alternatively be adopted.

Furthermore, an exhaust gas bypass passage that bypasses the turbine wheel 24 and a waste gate valve that opens and closes this exhaust gas bypass passage may be installed on the internal combustion engine 110 according to the fifth embodiment. If this kind of configuration is adopted, at least a part of an exhaust gas bypass passage may be arranged inside a cylinder head, and a waste gate valve may be embedded in the cylinder head.

### 6. Sixth Embodiment

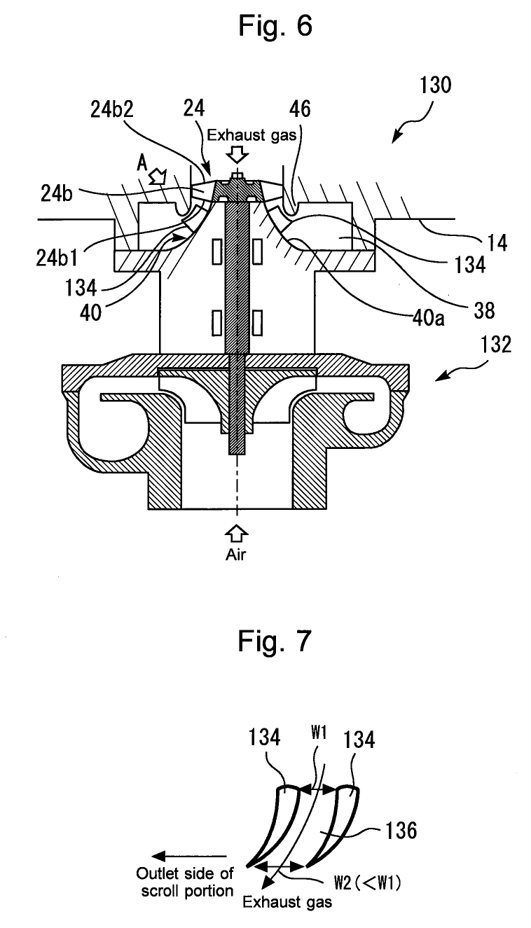

Next, a sixth embodiment according to the present disclosure will be described with reference to FIGS. 6 and 7.

### 6-1. Configuration of Main Part of Internal Combustion Engine

FIGS. 6 and 7 are diagrams that schematically illustrate the configuration of a main part of an internal combustion engine 130 according to the sixth embodiment of the present disclosure. The internal combustion engine 130 according to the present embodiment is different from the internal combustion engine 10 according to the first embodiment in terms of the configuration around the outlet of the turbine wheel 24.

Specifically, a turbocharger 132 which the internal combustion engine 130 includes is equipped with a plurality of nozzle plates 134. The plurality of nozzle plates 134 are arranged on a peripheral wall surface 40a of the turbine outlet wall portion 40. In more detail, the plurality of nozzle plates 134 are formed so as to be spaced by a predetermined distance from each other in the circumferential direction of the turbine outlet wall portion 40 and to perpendicularly extend in the radial direction thereof. In addition, the plurality of nozzle plates 134 are formed so as to divide the flow of the exhaust gas in association with the protrusion 46 and the peripheral wall surface 40a.

FIG. 7 is a view of two adjacent nozzle plates 134 from the direction of an arrow A in FIG. 6 (i.e., from the outside in the radial direction of the rotational shaft 30). The exhaust gas flows between the nozzle plates 134 adjacent to each other. Nozzles 136 are each formed between the nozzle plates 134 adjacent to each other.

As shown in FIG. 7, a width W2 between the adjacent nozzle plates 134 in the vicinity of the outlet of the exhaust gas is greater than a width W1 therebetween in the vicinity of the inlet of the exhaust gas. In more detail, each of the nozzles 136 is formed such that the width W between the adjacent nozzle plates 134 gradually becomes greater as the exhaust gas flows downstream. In addition, according to the example shown in FIG. 6, the height of the nozzles 136 (i.e., the distance between the peripheral wall surface 40a and the protrusion 46) also gradually becomes greater as the exhaust gas flows downstream. Thus, the flow passage cross-sectional area of each of the nozzles 136 gradually becomes greater as the exhaust gas flows downstream. It should be noted that, in order to gradually increase the flow passage cross-sectional area of each of the nozzles 136, only any one of the width W and height of the nozzles 136 may be changed instead of the example described above.

Furthermore, when viewed from the direction shown in FIG. 7 (i.e., from the radial direction of the rotational shaft 30), each nozzle plate 134 is curved to be able to guide the flow of the exhaust gas such that the exhaust gas flows toward the outlet side of the scroll portion 42. It should be noted that the internal combustion engine 130 according to the present embodiment is based on the internal combustion engine 10 according to the first embodiment. However, nozzles similar to the nozzles 136 may alternatively be provided for each of the internal combustion engine 50, 70, 90 and 110 according to other second to fifth embodiments.

### 6-2. Advantageous Effects

As described so far, according to the turbocharger 132 of the internal combustion engine 130, the nozzles 136 are formed immediately downstream of the turbine wheel 24 by the use of the nozzle plates 134 (and also the peripheral wall surface 40a and the protrusion 46). According to this kind of nozzles 136, the flow passage of the exhaust gas located immediately downstream of the turbine wheel 24 can be gradually broadened as the exhaust gas flows downstream. Thus, the occurrence of separation of the flow of the exhaust gas in the turbine outlet passage 38 can be effectively reduced. Also, as a result of the exhaust gas being smoothed in this way, a turbine efficiency can be improved.

### 7. Seventh Embodiment

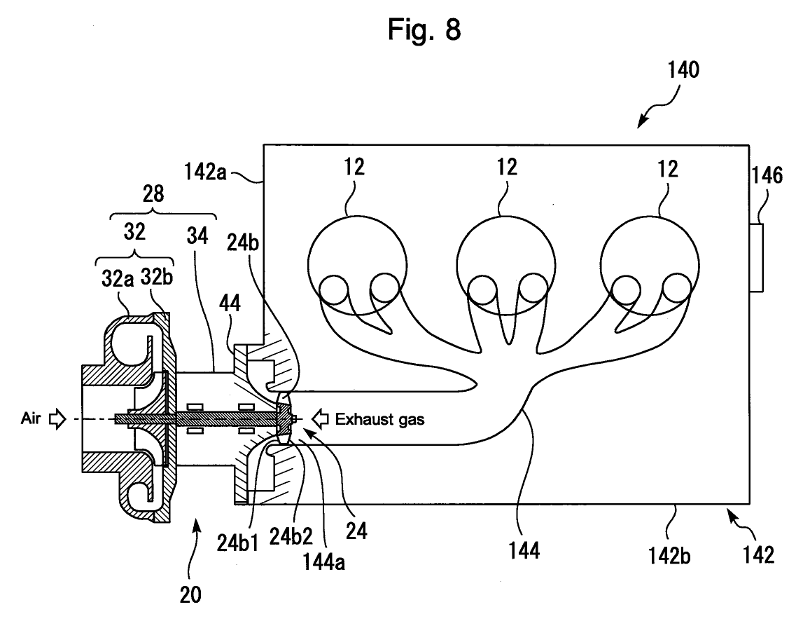

Next, a seventh embodiment according to the present disclosure will be described with reference to FIG. 8. FIG. 8 is a diagram that schematically illustrates the configuration of a main part of an internal combustion engine 140 according to the seventh embodiment of the present disclosure. The internal combustion engine 140 according to the present embodiment is different from the internal combustion engine 10 according to the first embodiment in terms of the installation location of the turbocharger 20.

Specifically, in a cylinder head 142 which the internal combustion engine 140 includes, a cylinder-head-inner gas passage 144 is formed. The exhaust gas discharged from each cylinder 12 flows through the cylinder-head-inner gas passage 144. A crank pulley 146 that is fixed to an end of a crankshaft (not shown) is arranged on one end side in the row direction of the cylinders 12 of the internal combustion engine 140. An outlet 144a of the cylinder-head-inner gas passage 144 shown in FIG. 8 opens to an outer surface 142a of the cylinder head 142 at a side surface of the cylinder head 142 located on the side opposite to the side of installation of the crank pulley 146 in the row direction. Also, according to the present embodiment, the turbocharger 20 is fastened to this outer surface 142a in a manner similar to that in the first embodiment.

According to the internal combustion engine 140 of the present embodiment described so far, advantageous effects similar to those of the internal combustion engine 10 of the first embodiment can be achieved. Moreover, the example of the installation location of the turbocharger 20 according to the present embodiment is favorable for a vehicle, for example, in which, when installing an internal combustion engine on the vehicle, a sufficient space is difficult to be secured in the direction of a side surface of a cylinder head located on the exhaust side (in the example of the internal combustion engine 140, in the direction of a side surface 142b). It should be noted that the example of the installation location shown in FIG. 8 may alternatively be applied to each of the internal combustion engines 50, 70, 90, 110 and 120 of other second to sixth embodiments.

### 8. Other Embodiments

### 8-1. Another Example of Installation of Housing on Cylinder Head

In the first embodiment described above, the housing 28 (bearing housing portion 34) of the turbocharger 20 is fastened to the cylinder head 14 such that the rotational shaft 30 becomes perpendicular to the side surface of the cylinder head 14. This also applies to the second to seventh embodiments. However, the example of installation of the “housing” according to the present disclosure with respect to a cylinder head is not limited to the example described above, as long as the housing is fastened to the cylinder head “such that a turbine wheel is opposed to the cylinder head”. That is to say, the housing may alternatively be installed such that the rotational shaft is not perpendicular to the side surface of the cylinder head but is inclined in a desired direction.

### 8-2. Another Example of Configuration of Turbine Outlet Passage

In the first embodiment described above, the scroll portion 42 that forms the turbine outlet passage 38 is formed using the cylinder head 14. Moreover, in the second and third embodiments, the scroll portions 58 and 80 are respectively formed using the turbine housing portion 56 and the bearing housing portion 76. However, the scroll portion that forms the turbine outlet passage may be formed using, for example, both of the cylinder head and the bearing housing portion, instead of the example described above. In other words, a part of the scroll portion may be formed using the cylinder head, and the remaining portion may be formed using the bearing housing portion.

### 8-3. Another Example of Axial Flow Turbine

In the first to seventh embodiments described above, the number (number of stages) of sets of the turbine blades 24b of the turbine wheel 24 is one. However, in order to increase the number of stages to the desired number of stages, the “axial flow turbine” according to the present disclosure may include a plurality sets of turbine blades arranged in a row in the direction of the rotational shaft instead of the example described above. It should be noted that, in an example in which a plurality of sets of turbine blades are included, an inlet of a set of turbine blades located on the uppermost stream side of the exhaust gas flow corresponds to an example of the “inlet of the turbine blades” mentioned in the present disclosure, and an outlet of a set of turbine blades located on the lowermost stream side of the exhaust gas flow corresponds to an example of the “outlet of the turbine blades” mentioned in the present disclosure.

The embodiments and modification examples described above may be combined in other ways than those explicitly described above as required and may be modified in various ways without departing from the scope of the present disclosure.

What is claimed is:

1. An internal combustion engine, comprising:
an exhaust gas passage through which exhaust gas discharged from a cylinder flows;
a water-cooled cylinder head;
a turbocharger,
the turbocharger including:
a compressor impeller;
an axial flow turbine wheel coupled to the compressor impeller through a rotational shaft;
a bearing that supports a portion of the rotational shaft located between the compressor impeller and the turbine wheel; and
a housing that houses at least the compressor impeller and the bearing among the compressor impeller, the bearing and the turbine wheel,
wherein the turbine wheel is coupled to the rotational shaft such that an outlet of turbine blades of the turbine wheel is located on a side of the compressor impeller, and
wherein the housing is fastened to the cylinder head, directly or with a first gasket interposed between the housing and the cylinder head, such that the turbine wheel is opposed to the cylinder head.

2. The internal combustion engine according to claim 1,
wherein an inlet of the turbine blades is arranged on an upstream side of an exhaust gas flow relative to a fastening surface of the housing with respect to the cylinder head.

3. The internal combustion engine according to claim 2,
wherein the exhaust gas passage includes a cylinder-head-inner gas passage formed inside the cylinder head, and
wherein the turbine wheel is arranged in the cylinder-head-inner gas passage.

4. The internal combustion engine according to claim 3,
wherein a peripheral surface of the cylinder-head-inner gas passage is opposed to the turbine blades in a radial direction of the turbine wheel.

5. The internal combustion engine according to claim 3,
wherein the housing includes a turbine housing portion that covers the turbine wheel,
wherein at least a part of the turbine housing portion is inserted into the cylinder-head-inner gas passage, and
wherein an inner peripheral surface of the turbine housing portion is opposed to the turbine blades in a radial direction of the turbine wheel.

6. The internal combustion engine according to claim 3, further comprising a second gasket arranged between the cylinder-head-inner gas passage and the turbine wheel, and
wherein an inner peripheral surface of the second gasket is opposed to the turbine blades in a radial direction of the turbine wheel.

7. The internal combustion engine according to claim 1,
wherein the housing includes a bearing housing portion that houses the bearing, and
wherein the bearing housing portion is fastened to the cylinder head directly or with the first gasket interposed between the bearing housing portion and the cylinder head.

8. The internal combustion engine according to claim 1, further comprising an exhaust gas purifying catalyst arranged in a portion of the exhaust gas passage located on a downstream side of the turbine wheel,
wherein the exhaust gas passage includes a catalyst upstream passage configured to connect the outlet of the turbine blades and the exhaust gas purifying catalyst, and
wherein at least a part of the catalyst upstream passage is formed inside the cylinder head.

9. The internal combustion engine according to claim 1,
wherein the turbocharger further includes a nozzle arranged at a portion of the exhaust gas passage located on a downstream side of the turbine wheel, and
wherein the nozzle is formed such that a cross-sectional area of the nozzle gradually becomes greater as the exhaust gas flows downstream.
